(19) United States
(12) Patent Application Publication
(10) Pub. No.: US 2013/0216675 A1
(43) Pub. Date: Aug. 22, 2013

(54) PLIABLE SUPPORT FOR A FOOD PRODUCT OR PREPARATION IN A ROASTING PAN

(71) Applicants: Dean B. CHAPMAN, New York, NY (US); Matthew L. CHIN, New York, NY (US); David LEE, Fishkill, NY (US); William G. STRYNKOWSKI, Pearl River, NY (US)

(72) Inventors: Dean B. CHAPMAN, New York, NY (US); Matthew L. CHIN, New York, NY (US); David LEE, Fishkill, NY (US); William G. STRYNKOWSKI, Pearl River, NY (US)

(21) Appl. No.: 13/633,617

(22) Filed: Oct. 2, 2012

Related U.S. Application Data
(60) Provisional application No. 61/601,543, filed on Feb. 21, 2012.

(51) Int. Cl. A47J 37/06; A23L 1/01

(52) U.S. Cl. 426/523; 99/449

(57) ABSTRACT

A support for providing a stable resting place for a food product being cooked in a roasting pan. The support has a pliable spine and a plurality of heat resistant elements that extend outwardly from the spine. The spine has a core member, such as a wire, that enables it to be manipulated by a user into a variety of shapes so as to be adaptable to support foods having different shapes and sizes. The spine and heat resistant elements can be molded of silicone with the core member molded therewithin. The heat resistant elements may be formed in a variety of shapes, and can be molded into various decorative shapes such as leaves, and as illustrated herein, give the appearance of a laurel.

### RELATED APPLICATION

The present application claims the benefit under 35 U.S.C. §119 of U.S. Provisional Application Ser. No. 61/601,543 filed Feb. 21, 2012. The content of said provisional application is hereby incorporated by reference in its entirety.

### BACKGROUND

The present invention relates to a device for supporting the position of a food product or preparation as it is roasted, and, more particularly, to a pliable, elongated support that can be manipulated into a variety of configurations to retain and support a food product during the roasting thereof.

It is certainly common to roast various foods, and particularly, meats such as beef, chicken and turkey and the like, in roasting pans. During the roasting process, however, it is desirable to elevate the food away from contact with the bottom of the roasting pan, as this would avoid permitting the food to sit and cook in the liquid fat and burned bits of food that accumulate at the bottom of the roasting pan. In addition, the separation of the food from the bottom of the roasting pan facilitates more even cooking of the entire portion of food being prepared, as the heat can more uniformly reach the full exterior surface of the portion.

It is known that flat racks are used to raise food being heated, away from the bottom of a roasting pan. However, a difficulty with the use of the racks is that the various foods to be roasted are of differing configurations and sizes such that the food may not sit firmly on the flat surface of a rack. In addition, the use of racks and the like also makes the uniform heating of the food difficult, as the racks contact a relatively large surface of the food being roasted and, again, the heat is not distributed evenly around the roasting food.

The racks can also be difficult to handle, and a rack for one roasting pan may not fit into a differently sized roasting pan, so that multiple racks are often required for multiple roasting pans.

It would therefore be advantageous to have a support that could be placed in the bottom of a roasting pan to elevate the food away from the bottom of the roasting pan and which could be shaped according to the configuration and size of the particular food being roasted in the roasting pan, as well as the size and shape of the pan.

It would also be advantageous to have a low cost support that would retain foods of different shapes and sizes in a stable orientation with a minimum of actual contact with the food being roasted in the roasting pan, and that would be usable with roasting pans of differing size.

### SUMMARY OF THE INVENTION

Accordingly, the present invention relates to a versatile food support that can be used to suspend and retain, in a stable manner, a food product or preparation as it is being heated in an oven (roasted), and is disposed in a roasting pan. The support is adaptable, and is capable of configuration in a variety of shapes and conformations. The present support can be manipulated into a particular desired shape, so as to be best suited for the suspension and retention of the shape and size of the food product being roasted. Likewise, the support is capable of manipulation to accommodate both food products of differing shapes and sizes, as well as differently sized roasting pans.

The support has an elongated pliable spine that has a plurality of spaced apart heat resistant elements extending outwardly therefrom. The spine and heat resistant elements are preferable molded from a material that is heat resistant, such as silicone. In a particular aspect, the heat resistant material may be a resin, and particularly a food-grade silicone resin.

A core member, such as a wire, can be molded into the spine. The core member is also bendable, so that the resulting support can be manipulated into a wide variety of desired configurations by the user depending upon the size and shape of the food to be roasted. Once formed, the support will stably retain the desired configuration.

By such means, the support can be manipulated into a particular shape that is supportive of a certain size and shape of the food. The support can then be placed in the bottom of a roasting pan, and the food positioned atop of and retained by the support in a stable manner such that the food is elevated and out of contact with the bottom of the roasting pan to prevent it from sitting in any fat and burned bits of food, that may be formed or result from the roasting process.

These and other features and advantages of the present invention will become more readily apparent during the following detailed description taken in conjunction with the drawings herein.

### BRIEF DESCRIPTION OF THE DRAWINGS

FIG. 1 is a top view of a support constructed in accordance with the present invention;

FIG. 2 is a side view of the support of FIG. 1;

FIG. 3 is a bottom view of the support of FIG. 1;

FIG. 4 is an end view of the support of FIG. 1;

FIG. 5 is a cross sectional, perspective view of the support of FIG. 1;

FIG. 6 is a perspective view of the support of FIG. 1;

FIG. 7 is a perspective view of the support of FIG. 1 manipulated into a U-shape configuration;

FIG. 8 is a is a perspective view of the support of FIG. 1 manipulated into a circular configuration;

FIG. 9 is a perspective view of the support of FIG. 1 manipulated into an S-shaped configuration;

FIG. 10 is a perspective view of a support of FIG. 1 manipulated such that a distal end of the support is attached to itself along the length thereof;

FIG. 11 is a perspective view illustrating the manual manipulation of the support of the present invention to form a desired configuration; and

FIG. 12 is a perspective view, partially cut away, showing the support of the present invention contained within a roasting pan and supporting a food for roasting.

### DETAILED DESCRIPTION OF THE INVENTION

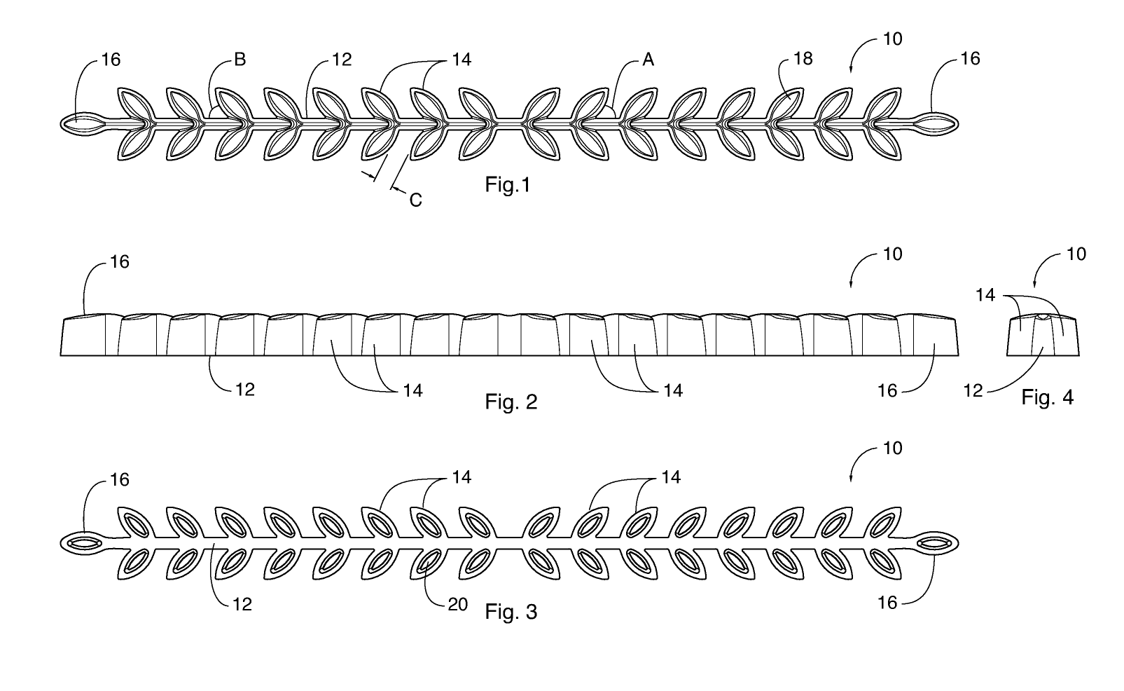

Referring now to FIGS. 1-4, there are shown a top view, side view, bottom view and an end view, respectively, of a support 10 that is used to suspend and retain a food product in a stable manner during the roasting thereof. As can be seen, the support 10 comprises an elongated spine 12 that extends substantially the full length of the support 10. The elongated spine 12 is comprised of a pliable material and, in the exemplary embodiment, the material is a heat resistant material such as silicone that is sufficiently heat resistant to enable the support 10 to be resident in a heated oven for a period of time to carry out the cooking of a food. In particular, the pliable material may be a synthetic resin, and more particularly, may be a food grade formulation, such as a suitable silicone.

A plurality of heat resistant elements 14 extend outwardly from the elongate spine 12 and, in the exemplary embodiment, the heat resistant elements are grouped in oppositely disposed pairs of heat resistant elements 14 that extend the full length of the elongated spine 12 as well as two end heat resistant elements 16 that extend axially outwardly at each end of the support 10.

In the exemplary embodiment of FIGS. 1-4, the heat resistant elements 14 as illustrated are configured so as to extend outwardly in opposite directions; that is, some of the heat resistant elements 14 are directed at an acute angle A with respect to the spine 12 toward one end of heat resistant element 16, while other elements 14 extend at an acute angle B with respect to the spine 12 toward the opposite end of heat resistant element 16. As will later become clear, the spacing C between adjacent heat resistant elements 14 is also preferably controlled, and such spacing may be equal to or just slightly less that the width of the end heat resistant elements 16.

Again, as shown in the embodiment of FIG. 1, the heat resistant elements 14 can be comprised of silicone and molded in a unitary mold along with the elongated spine 12. As illustrated herein, the heat resistant elements 14 and end heat resistant elements 16 can be molded in the shape of leaves in order to present an aesthetically pleasing appearance such that the complete support 10 can have the appearance of a laurel. Of course, it will be appreciated that other shapes of heat resistant elements can be used consistent with the intent and purpose of the present invention.

As another feature, the heat resistant elements 14 and end heat resistant elements 16 can be hollow with large openings 18 in their upper surfaces and smaller openings 20 in their lower surfaces. Alternatively, the heat resistant elements 14 and end heat resistant elements 16 may be molded as solid components.

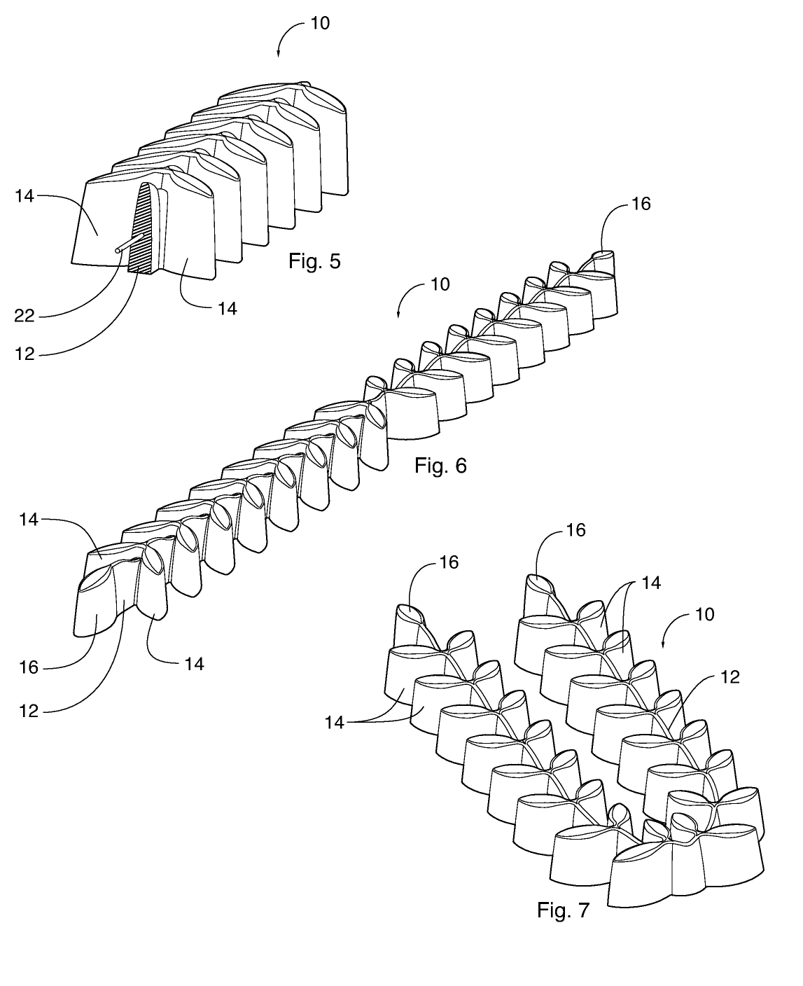

Referring now to FIG. 5, there is shown a perspective, cross sectional view of the support 10 of the present invention. Thus, there can be seen a core member 22 that is molded into the elongated spine 12. The core member 22 is a bendable material, such as a wire, but can be other materials, where the support 10 can be bent into a desired position. The core member 22 allows the support 10 to remain in the shape that has been manually manipulated by the user.

In the exemplary embodiment, the core member 22 can be molded into the elongated spine 12 in the molding process that produces the support 10 such that the support 10 is a unitary molded product.

Referring now to FIGS. 6 and 7, there are shown, respectively, perspective views of the support 10 of the present invention in a straight configuration, and in a U-shaped configuration. In the practice of the present invention, the straight configuration of FIG. 6 may be manually manipulated by a user to take on the U-shaped configuration of FIG. 7.

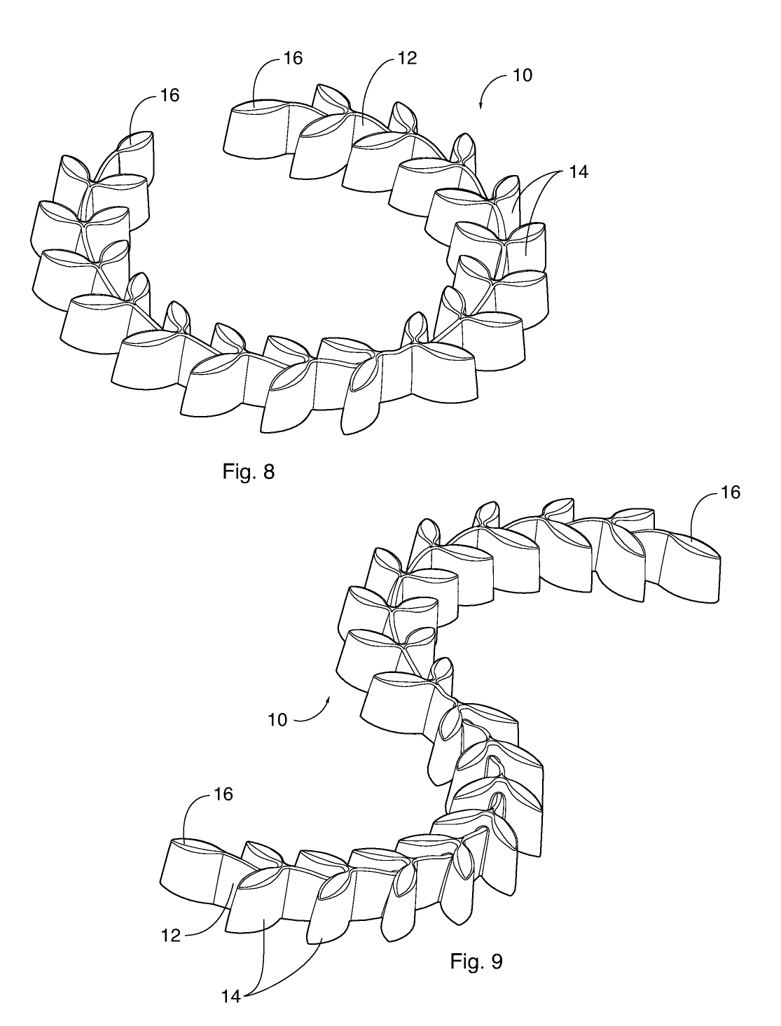

Other configurations that may be formed are shown in FIGS. 8 and 9 where the support 10 is shaped into a circular configuration (FIG. 8) and an S-shaped configuration (FIG. 9).

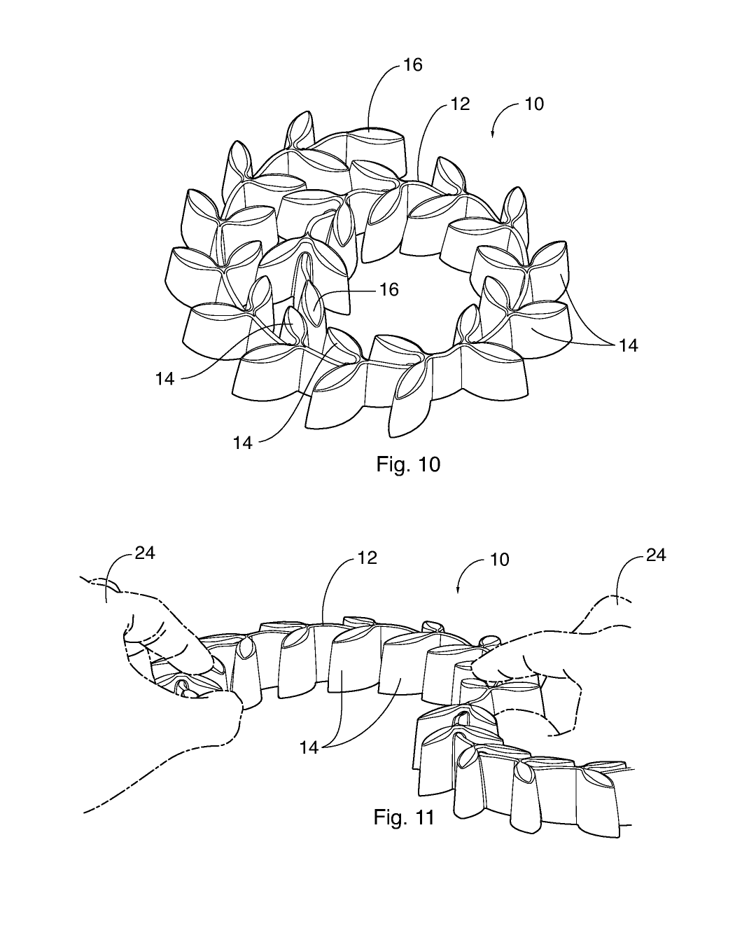

Referring now to FIG. 10, there is shown another feature of the present invention in that the support 10 has been manipulated into a circular shape and connected to itself. In this embodiment, an end heat resistant element 16 has been manipulated and can be inserted intermediate two adjacent heat resistant elements 14 in a ‘snap fit’-like engagement therebetween. As such, rather than have an end heat resistant element 14 simply at a distally isolated location, it can be connected to itself, such as by a ‘snap fit’ engagement at a selected location of adjacent heat resistant elements 14, to form a closed geometric configuration.

Referring now to FIG. 11, there is shown a support 10 in the process of being manipulated by the hands 24 of a user and, as can be seen, the user can change the shape of the support 10 by manipulating the support 10 to create a particular shape of support that is desired for use with a particular size or shape of food product that is being roasted.

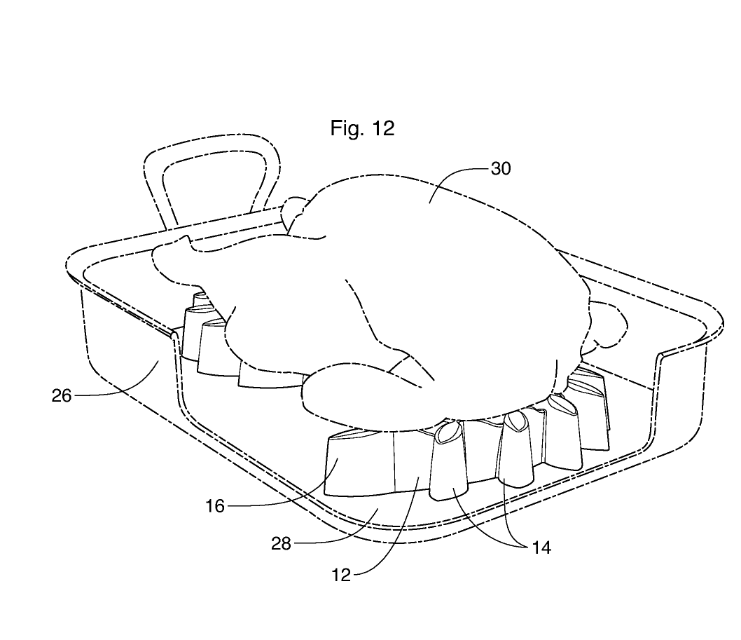

Referring finally to FIG. 12, there is shown a perspective view, partially cut away, of a roasting pan 26 having a bottom 28 and having a food product 30 resting in the roasting pan 26. The food product 30 as shown is a turkey, however, as described, the versatility of the present support 10 allows the support 10 to be manipulated into any particular desired configuration so as to be applicable for supporting a wide variety of foods to be roasted.

Thus, in FIG. 12, the food product 30 is held in a stable position elevated and out of contact with the bottom 28 of the roasting pan 26, so that it is not cooking in the accumulated fat and burned bits of food that will collect on bottom 28 during the cooking process. The particular configuration of the support 10 is therefore specially adapted by manipulation by the user to provide a solid resting base for food product 30, so as to create a uniform cooking environment for food product 30.

Those skilled in the art will readily recognize numerous adaptations and modifications which can be made to the flexible support and use thereof of the present invention which will result in an improved support, yet all of which will fall within the scope and spirit of the present invention as defined in the following claims Accordingly, the invention is to be limited only by the following claims and their equivalents.

What is claimed is:

1. A support for supporting a food during roasting thereof, the support comprising a pliable elongated spine comprised of a heat resistant material, a bendable core member molded within the spine and a plurality of heat resistant elements molded to and extending outwardly from the elongated spine, wherein the support can be manipulated to a desired shape for supporting foods having differing shapes and sizes.

2. The support as defined in claim 1 wherein heat resistant elements are leaf shaped so as to provide an overall appearance of a support as a laurel.

3. The support as defined in claim 1 wherein the core member is a wire.

4. The support as defined in claim 3 wherein the wire is molded into and extends at least substantially the full length of the pliable spine.

5. The support as defined in claim 1 wherein the elongated spine and the heat resistant members are comprised of silicone.

6. The support as defined in claim 1 wherein the support has an end heat resistant element that can be joined by a snap fit between two adjacent heat resistant elements.

7. The support as defined in claim 1 wherein the heat resistant elements are grouped in pairs oppositely extending outwardly from the pliable spine.

8. The support as defined in claim 7 wherein each pair of heat resistant elements extends from the pliable spine at an acute angle with respect to the pliable spine.

9. The support as defined in claim 1 wherein the heat resistant elements are hollow.

10. A method of supporting a food for roasted within a roasting pan having a bottom surface, the method comprising the steps of:
providing a support having a pliable elongated spine comprised of a heat resistant material, a bendable core member molded within the elongated spine and a plurality of heat resistant elements molded to and extending outwardly from the elongated spine, manually manipulating the support to form a shape that supports the food in a position vertically spaced above the bottom surface of the roasting pan ; and
placing the food atop of the formed structure for roasting the food.
